(19) United States
(12) Patent Application Publication
(10) Pub. No.: US 2019/0155023 A1
(43) Pub. Date: May 23, 2019

(54) METHOD FOR CORRECTING WAVEFRONT DISTRIBUTION OF AN OPTICAL SYSTEM BY LASER

(71) Applicant: Inno Laser Technology Corporation Limited, Shenzhen (CN)

(72) Inventors: Xiaojie Zhao, Ronkonkoma, NY (US); Sha Tao, Shenzhen (CN)

(21) Appl. No.: 16/234,930

(22) Filed: Dec. 28, 2018

Related U.S. Application Data
(63) Continuation of application No. PCT/CN2017/106245, filed on Oct. 16, 2017.

(30) Foreign Application Priority Data
Jul. 27, 2017 (CN) 201710623727.9

(51) Int. Cl. G02B 27/00; B23K 26/352

(52) U.S. Cl. CPC G02B 27/0025; B23K 2103/54; B23K 26/352

(57) ABSTRACT

A method for correcting wavefront distribution of an optical system by laser, mainly utilizes the action of the laser to form a desired refractive index spatial distribution inside an optical component, thereby correcting a wavefront distortion existing in an optical system, or to obtain an optical system having a desired wavefront distribution. The optical component processed by the method could effectively correct the wavefront distortion existing in the optical system, to meet specific use requirements, and the optical component could be used in various optical systems. At the same time, the method has the characteristics of fast speed, computer-aided one-step forming and no subsequent processing, and is a new method for optical system design and wavefront distortion correction.

### CROSS REFERENCE TO RELATED APPLICATION

This application is a continuation application of PCT/CN2017/106245, field on Oct. 16, 2017, which claims the benefit of Chinese Patent application No. 201710623727.9 filed on Jul. 27, 2017, the contents of which are all hereby incorporated by reference.

### FIELD OF THE INVENTION

The present application relates to the technical field of optoelectronic, and more particularly, to a method for correcting wavefront distribution of an optical system by laser.

### BACKGROUND OF THE INVENTION

When passing through some optical components, a beam may generate a wavefront distortion. Traditional wavefront distortion correction methods comprise a plurality of manners, such as using a combination of multiple lenses, or combining with an optical component to correct the refractive index, or using a curve design with different thicknesses. However, all of the above methods require complex optical structure design, and some optical systems are complicated. If the entire optical system is added the complex optical structure design to correct the wavefront distortion, the entire optical system will become more complicated.

### SUMMARY OF THE INVENTION

The embodiments of the present application provide a method for correcting wavefront distribution of an optical system by laser, comprising the following steps:

S1, acquiring an actual wavefront distribution of the optical system to be corrected before correcting;

S2, calculating a desired refractive index spatial distribution that an optical component for correction needs to have after correction according to the wavefront distribution acquired by the step S1;

S3, utilizing a laser to act on the optical component, to generate the desired refractive index spatial distribution inside the optical component;

S4, placing the optical component processed by the step S3 in the optical system, to correct a wavefront distortion existing in the optical system, or to obtain an optical system having a desired wavefront distribution.

Further, in the step S1, the actual wavefront distribution of the optical system to be corrected before correcting could be measured or calculated by an instrument.

Further, in the step S2, firstly acquiring the wavefront distortion existing in the optical system according to the wavefront distribution acquired by the step S1, and then calculating the desired refractive index spatial distribution that the optical component for correction needs to have according to the wavefront distortion.

Further, in the step S2, the desired refractive index spatial distribution is determined by calculation and simulation according to the wavefront distribution acquired by the step S1.

Further, in the step S3, measuring a refractive index spatial distribution of the optical component after utilizing the laser to act on the optical component, and if the refractive index spatial distribution reaches the desired refractive index spatial distribution, finish the processing of the optical component; if the refractive index spatial distribution does not reach the desired refractive index spatial distribution, then repeat from the step S2 until that the refractive index spatial distribution of the optical component reaches the desired refractive index spatial distribution.

Further, the optical component for correction is at least one optical component in the optical system from a start point of an optical path to an end point of the optical path.

Further, the optical component for correction is an optical compensation component added to the optical system.

The novel method for correcting wavefront distribution of an optical system by laser of the embodiments of the present application may also be a laser processing method for wavefront correction of an optical system or for generating a special optical system with a desired arbitrary wavefront distribution. The method mainly utilizes the action of the laser to form a desired refractive index spatial distribution inside an optical component, thereby realizing correction. The optical component processed by the method could effectively correct the wavefront distortion existing in the optical system, or could be used to generate a special optical system having a desired arbitrary wavefront distribution to meet specific use requirements, and the optical component could be used in various optical systems. At the same time, the method has the characteristics of fast speed, computer-aided one-step forming and no subsequent processing, and is a new method for optical system design and wavefront distortion correction.

### BRIEF DESCRIPTION OF THE DRAWINGS

The specific solution of the present application will be described in detail below with reference to the accompanying drawings.

FIG. 1 is a flow chart of a laser processing method for wavefront correction of an optical system of an embodiment of the present application;

FIG. 2 is a structural diagram of an optical system of an embodiment of the present application.

Wherein, 1-Industrial personal computer, 2-Laser, 3-Beam expanding device, 4-Optical compensation component, 5-Vibrating mirror, 6-Lens, 7-Laser beam, 8-Processing platform.

### DESCRIPTION OF THE EMBODIMENTS

In order to describe the technical content, structural features, achieved objects and effects of the present application in detail, the following detailed description about how to specifically use the method to correct the wavefront distortion problem existing in an optical system will be described with reference to the embodiments and the accompanying drawings.

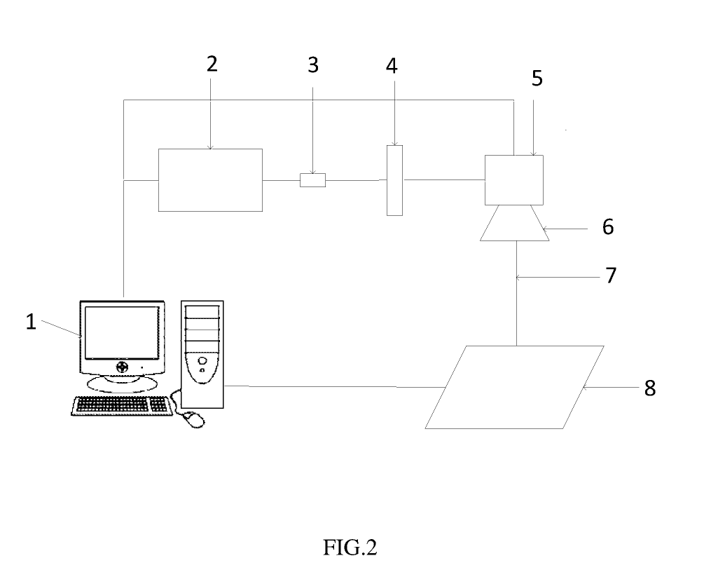

Referring to FIG. 2, it is an already constructed optical system, which comprises an industrial personal computer 1, a laser 2, a beam expanding device 3, a vibrating mirror 5, a lens 6 and a processing platform 8 in sequence, and a laser beam 7 is emitted from the laser 2, and then passes through a series of optical components to reach the processing platform 8 and acts on the workpiece to be processed on the processing platform 8, to obtain the desired processing effect. Due to the problems of the optical components themselves or the optical system, the entire optical system may more or less have some wavefront distortion.

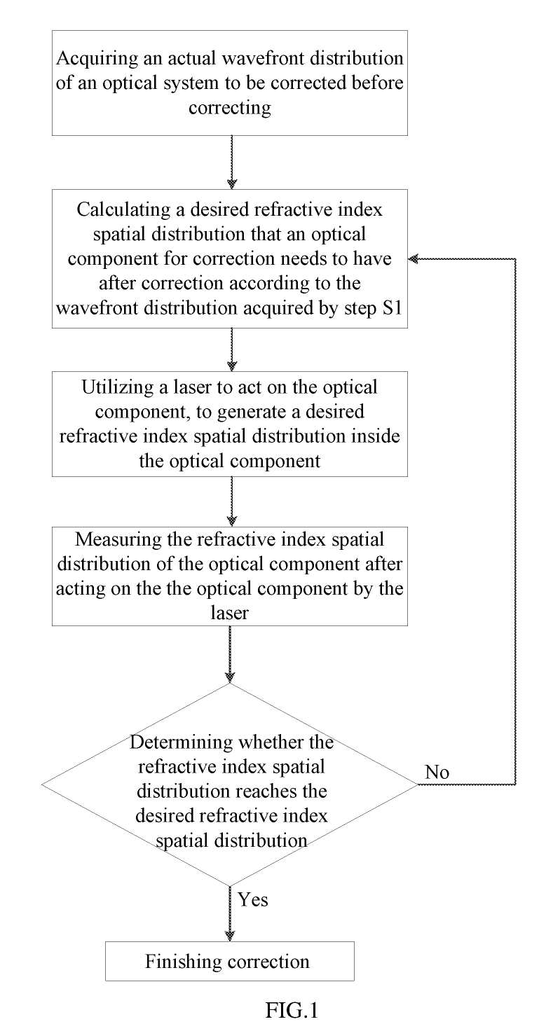

Referring to FIG. 1, in order to correct the above wavefront distortion, the embodiment of the present application utilizes the action of laser to a transparent material, and changes the refractive index spatial distribution inside the transparent material by the action of the laser, then place the transparent material in the original optical system, thereby correcting the wavefront distortion of the optical system. Specifically, the method comprises the following steps:

S1, acquiring an actual wavefront distribution of an optical system to be corrected before correcting;

S2, calculating a desired refractive index spatial distribution that an optical component for correction needs to have after correction according to the wavefront distribution acquired by step S1, that is, theoretically, the refractive index spatial distribution that the optical device needs to achieve in order to complete the correction of the wavefront distortion of the optical system;

S3, utilizing a laser to act on the optical component, to generate a desired refractive index spatial distribution inside the optical component;

S4, placing the optical component processed by step S3 in the optical system to correct the wavefront distortion existing in the optical system.

Preferably, in the step S1, the actual wavefront distribution of the optical system to be corrected before correcting could be measured or calculated by an instrument.

Preferably, in the step S2, firstly acquiring the wavefront distortion existing in the optical system according to the wavefront distribution acquired by step S1, and then calculating the refractive index spatial distribution that the optical component for correction needs to have according to the wavefront distortion. There exists the distortion in the optical system, and the correction of the optical system is to eliminate the distortion, therefore, the optical component's refractive index spatial distribution corresponding to the corrected optical system after eliminating the distortion could be calculated according to the distortion.

Preferably, in the step S3, after utilizing the laser to act on the optical component, measure the refractive index spatial distribution of the optical component, and if the refractive index spatial distribution reaches the desired refractive index spatial distribution, finish the processing of the optical component; if the refractive index spatial distribution does not reach the desired refractive index spatial distribution, then repeat from the step S2 until that the refractive index spatial distribution of the optical component reaches the desired refractive index spatial distribution. About utilizing the laser to act on the optical component to change the refractive index spatial distribution of the optical component, the computer-aided one-step forming could be used to make the optical component achieve the desired refractive index spatial distribution. At the same time, due to the actual processing error, or certain optical components need to be processed by multiple times to improve the precision, therefore, after processing once, measure the refractive index spatial distribution of the processed optical component, and determine whether it is necessary to process the optical component one more time according to the actual refractive index spatial distribution and the wavefront distortion at this time. If not necessary, directly one-step form. If necessary, utilize the laser to repeatedly act on the optical component according to the operation in step S2 until reaching the desired spatial distribution of the refractive index, to eliminate the wavefront distortion existing in the optical system.

Preferably, the optical component for correction may be any at least one optical component in the optical system from the start point of the optical path to the end point of the optical path. The wavefront distortion is a distortion of the entire optical system. To eliminate the distortion, select any optical component from the start point to the end point of the optical path in the optical system, and according to the distortion of the system and the refractive index spatial distribution of the selected optical device itself, determine how to process the selected optical component and the refractive index spatial distribution that the selected optical component needs to have after processing, and ultimately eliminating the wavefront distortion existing in the optical system.

Preferably, the optical component for correction may be an optical compensation component added to the optical system. The processed optical component may be any optical component in the optical path, and may also be an optical compensation component added to the optical system. Similarly, perform the laser processing according to the wavefront distortion existing in the optical system and the refractive index spatial distribution of the optical compensation component itself, to make the refractive index spatial distribution of the optical compensation component reach a desired refractive index spatial distribution, thereby ultimately eliminating the wavefront distortion existing in the optical system.

The embodiment of the present application provides a novel method for correcting wavefront distribution of an optical system by laser, mainly selecting any one optical component from the start point to the end point of the optical path, or an additional optical compensation component such as an optical compensation plate, calculating a desired refractive index spatial distribution of the optical component for correction in combination with the wavefront distortion of the entire optical system, and then generating the desired refractive index spatial distribution inside the optical component by the action of the laser, to eliminate the wavefront distortion of the optical system, thereby realizing the correction. The optical component processed by the method could effectively correct the wavefront distortion of the optical system to meet specific use requirements and could be used in various optical systems. At the same time, the method has the characteristics of fast speed, computer-aided one-step forming and no subsequent processing, and is a new method for optical system design and wavefront distortion correction.

Here, the up, down, left, right, front and back only represent their relative positions, and do not represent their absolute positions. The above description is only the embodiments of the present application, and is not intended to limit the scope of the present application. The equivalent structures or equivalent flow transformations, or the directly or indirectly application in other related technology field according to the specification and the accompanying drawings should all fall into the protection scope of the present application.

What is claimed is:

1. A method for correcting wavefront distribution of an optical system by laser, comprising the following steps:
S1, acquiring an actual wavefront distribution of the optical system to be corrected before correcting;
S2, calculating a desired refractive index spatial distribution that an optical component for correction needs to have after correction according to the wavefront distribution acquired by the step S1;
S3, utilizing a laser to act on the optical component, to generate the desired refractive index spatial distribution inside the optical component;
S4, placing the optical component processed by the step S3 in the optical system, to correct a wavefront distortion existing in the optical system, or to obtain an optical system having a desired wavefront distribution.

2. The method for correcting wavefront distribution of an optical system by laser according to claim 1, wherein in the step S1, the actual wavefront distribution of the optical system to be corrected before correcting could be measured or calculated by an instrument.

3. The method for correcting wavefront distribution of an optical system by laser according to claim 1, wherein in the step S2, firstly acquiring the wavefront distortion existing in the optical system according to the wavefront distribution acquired by the step S1, and then calculating the desired refractive index spatial distribution that the optical component for correction needs to have according to the wavefront distortion.

4. The method for correcting wavefront distribution of an optical system by laser according to claim 1, wherein in the step S2, the desired refractive index spatial distribution is determined by calculation and simulation according to the wavefront distribution acquired by the step S1.

5. The method for correcting wavefront distribution of an optical system by laser according to claim 1, wherein in the step S3, measuring a refractive index spatial distribution of the optical component after utilizing the laser to act on the optical component, and if the refractive index spatial distribution reaches the desired refractive index spatial distribution, finish the processing of the optical component; if the refractive index spatial distribution does not reach the desired refractive index spatial distribution, then repeat from the step S2 until that the refractive index spatial distribution of the optical component reaches the desired refractive index spatial distribution.

6. The method for correcting wavefront distribution of an optical system by laser according to claim 1, wherein the optical component for correction is at least one optical component in the optical system from a start point of an optical path to an end point of the optical path.

7. The method for correcting wavefront distribution of an optical system by laser according to claim 1, wherein the optical component for correction is an optical compensation component added to the optical system.
